(19) United States
(12) Patent Application Publication
(10) Pub. No.: US 2026/0070608 A1
(43) Pub. Date: Mar. 12, 2026

(54) STEERING ASSEMBLY INCLUDING A STEERING WEAR COMPENSATOR SYSTEM HAVING AN ACTIVE PRESSURE CONTROL SYSTEM

(71) Applicant: GM Global Technology Operations LLC, Detroit, MI (US)

(72) Inventors: Seokju YONG, Bucheon-si (KR); Kwangyoung Kim, Incheon (KR); Seunghwan Yang, Yangcheon-gu (KR); Wanhee Do, Seoul (KR)

(21) Appl. No.: 18/829,077

(22) Filed: Sep. 9, 2024

(51) Int. Cl. B62D 5/30; B62D 5/065; B62D 5/22

(52) U.S. Cl. CPC B62D 5/30; B62D 5/065; B62D 5/22

(57) ABSTRACT

A wear compensator for a rack and pinion steering assembly having a rack in engagement with a pinion shaft gear in a steering housing includes a rack follower configured to slidably engage the rack, a hydraulic plunger configured to selectively apply pressure to the rack follower, a source of hydraulic pressure operatively connected to the hydraulic plunger, a rack profile sensor configured to detect forces on the rack resulting from engagement with the pinion shaft gear, and a wear compensator controller operatively connected to the rack profile sensor and the source of hydraulic pressure. The wear compensator controller being configured to adjust hydraulic pressure on the hydraulic plunger to selectively force the rack follower against the rack based on signals from the rack profile sensor.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to vehicle steering assemblies and, more particularly, to a wear compensator system having an active pressure control system for a vehicle steering assembly.

A vehicle includes a steering system for controlling driving direction. A driver may rotate a steering wheel to change the direction of the vehicle. The rotational movement of the steering wheel is transferred to a vehicle tie rod or a road wheel actuator. For example, the rotational movement of the steering wheel may be transferred via a mechanical connection between the steering wheel and the tie rod and/or via an electrical connection (e.g., a signal) to the road wheel actuator having a rack and a pinion. With respect to the road wheel actuator, the pinion is actuated based on the rotational movement of the steering wheel to cause translation of the rack resulting in movement of the vehicle wheels.

### SUMMARY

A wear compensator for a rack and pinion steering assembly having a rack in engagement with a pinion shaft gear in a steering housing, in accordance with the present disclosure, includes a rack follower configured to slidably engage the rack, a hydraulic plunger configured to selectively apply pressure to the rack follower, a source of hydraulic pressure operatively connected to the hydraulic plunger, a rack profile sensor configured to detect forces on the rack resulting from engagement with the pinion shaft gear, and a wear compensator controller operatively connected to the rack profile sensor and the source of hydraulic pressure. The wear compensator controller being configured to adjust hydraulic pressure on the hydraulic plunger to selectively force the rack follower against the rack based on signals from the rack profile sensor.

In other features, the source of hydraulic pressure defines an electronic brake control module (EBCM).

In other features, a normally closed valve is fluidically connected between the hydraulic plunger and the EBCM.

In other features, the rack follower includes a central recess exposed to the hydraulic plunger.

In other features, a spring is arranged in the central recess, the spring being operatively connected between the hydraulic plunger and the rack follower.

In other features, the source of hydraulic pressure is a steering wear compensation pump directly connected to the hydraulic plunger.

A wear compensator for a rack and pinion steering assembly having a rack in engagement with a pinion shaft gear in a steering housing includes a rack follower configured to slidably engage the rack, a hydraulic plunger configured to selectively apply pressure to the rack follower, a source of hydraulic pressure operatively connected to the hydraulic plunger, a rack profile sensor configured to detect forces on the rack, and an active pressure controller operatively connected to the rack profile sensor and the source of hydraulic pressure. The active pressure controller activating the source of hydraulic pressure to actively apply hydraulic pressure on the hydraulic plunger selectively forcing the rack follower against the rack based on signals from the rack profile sensor.

In other features, the source of hydraulic pressure defines an electronic brake control module (EBCM).

In other features, a normally closed valve is fluidically connected between the hydraulic plunger and the EBCM.

In other features, the rack follower includes a central recess exposed to the hydraulic plunger.

In other features, a spring is arranged in the central recess, the spring being operatively connected between the hydraulic plunger and the rack follower.

In other features, the source of hydraulic pressure is a steering compensator pump directly connected to the hydraulic plunger.

A method of biasing a rack to compensate for wear in a steering assembly includes monitoring hydraulic pressure on a hydraulic plunger, determining whether the hydraulic pressure is within a selected pressure range, adjusting pressure on the hydraulic plunger if the hydraulic pressure is not within the selected pressure range, and adjusting pressure on a rack follower of the steering assembly with the hydraulic plunger.

In other features, monitoring hydraulic pressure on the hydraulic plunger includes opening a normally closed valve to fluidically connect the steering assembly with an electronic brake control module (EBCM).

In other features, monitoring pressure on the rack of the steering assembly across a rack travel path.

In other features, developing a rack wear profile of the rack across the rack travel path.

In other features, developing the rack wear profile includes identifying pressure changes on the rack across the rack travel path.

In other features, determining a compensating pressure to balance pressure on the rack based on the rack wear profile.

In other features, adjusting the pressure on the hydraulic plunger includes applying the compensating pressure to the hydraulic plunger.

In other features, applying the compensating pressure includes activating a steering wear compensation pump directly connected to the hydraulic plunger.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an upper left perspective view of a vehicle including a steering wear compensator system with active pressure control, in accordance with the present disclosure;

FIG. 2 is a schematic view of a steering control system having the steering wear compensator system with active pressure control, in accordance with the present disclosure;

FIG. 3 is a cross-sectional view of the steering wear compensator system with active pressure control of FIG. 2, in accordance with the present disclosure;

FIG. 4 is a block diagram depicting a wear compensator controller, in accordance with the present disclosure;

FIG. 5 is a flow chart illustrating a method of steering wear compensation using active pressure control, in accordance with the present disclosure;

FIG. 6 is a flow chart illustrating a method of controlling pressure to the steering wear compensation system of FIG. 3 to prevent noise, in accordance with the present disclosure;

FIG. 7 is a schematic view of a steering control system having the steering wear compensator system with active pressure control, in accordance with an aspect of the present disclosure;

FIG. 8 is a cross-sectional view of the steering wear compensator system with active pressure control of FIG. 7, in accordance with the present disclosure;

FIG. 9 is a block diagram depicting a wear compensator controller, in accordance with another aspect of the present disclosure;

FIG. 10 is a flow chart illustrating a method of steering wear compensation using active pressure control, in accordance with an aspect of the present disclosure; and

FIG. 11 is a flow chart illustrating a method of controlling pressure to the steering wear compensation system of FIG. 8 to prevent noise, in accordance with the present disclosure.

In the drawings, reference numbers may be reused to identify similar and/or identical elements.

### DETAILED DESCRIPTION

Steering assemblies provide an interface between a driver and front vehicle wheels. Steering assemblies typically include a steering housing that supports a rack gear operatively connected to a pinion gear. Turning a steering wheel in a vehicle causes the pinion gear to rotate. Rotation of the pinion gear is transformed into linear movement of the rack gear. The rack gear includes opposing ends that are connected to front wheels of the vehicle through corresponding tie rods. Shifting the rack gear in the steering housing causes the front wheels to pivot.

During a majority of driving conditions, the rack gear is substantially centered in the steering housing. Thus, over time, a central portion of the rack gear typically experiences more wear than end portions of the rack gear. Wear on the central portion of the rack can lead to bending resulting in binding and noise in the steering assembly. To avoid binding and noise, many steering assemblies include mechanical wear compensation devices that include yolks, cams, and springs.

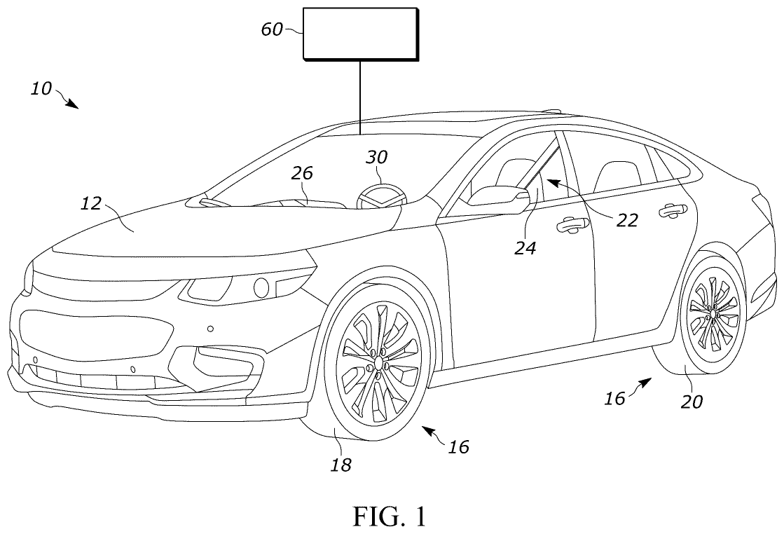

A vehicle, in accordance with the present disclosure, is indicated generally at 10 in FIG. 1. Vehicle 10 includes a body 12 supported by a plurality of wheels 16, including front wheels 18 and rear wheels 20. Front wheels 18 are steerable wheels. Body 12 defines, in part a passenger compartment 22 having a passenger seat 24 positioned behind a dashboard 26. A steering wheel 30 is disposed between passenger seat 24 and dashboard 26. Steering wheel 30 is operatively connected to front wheels 18.

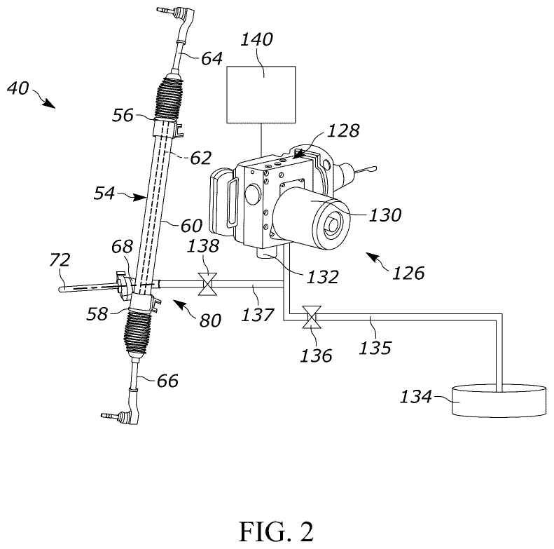

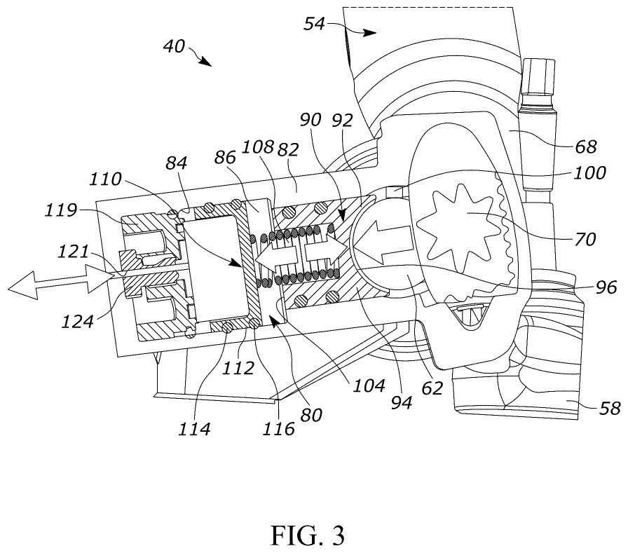

Referring to FIG. 2, a steering assembly 40 acts as an interface between front wheels 18 and steering wheel 30. Steering assembly 40 includes a steering housing 54 including a first end 56, a second end 58 that is opposite first end 56, and an intermediate portion 60. A rack 62 extends between first end 56 and second end 58. Rack 62 is shiftable in steering housing 54. A first tie rod 64 is connected to a first end portion (not shown) of rack 62 and extends from first end 56. A second tie rod 66 is connected to a second end portion (also not shown) of rack 62 and extends from second end 58. A gear housing 68 is arranged along intermediate portion 60. Gear housing 68 connects with steering wheel 30 and, to accommodate alignment with a driver, is positioned closer to second end 58 of steering housing 54 than to first end 56 of steering housing 54. Referring to FIG. 3, gear housing 68 supports a pinion 70. Pinion 70 is operatively connected to steering wheel 30 through a steering column 72. Pinion 70 meshingly engages with rack 62.

In accordance with the present disclosure, steering assembly 40 includes a wear compensation system 80 built into gear housing 68. As shown in FIG. 3, wear compensation system 80 includes a housing 82 that is operatively connected to gear housing 68. Housing 82 includes an internal surface 84 that defines a pressure chamber 86. A rack follower 90 is disposed in housing 82. Rack follower 90 includes a first shoe 92 and a second shoe 94. First shoe 92 is spaced from second shoe 94 by a rack recess 96. Rack 62 nests within and rides through rack recess 96 between first shoe 92 and second shoe 94. Housing 82 also supports a rack sensor 100 that detects forces on rack 62. Rack sensor 100 may be a torque sensor (not separately labeled) that detects torsional forces on steering column 72 when shifting rack 62 within steering housing 54.

As further shown in FIG. 3, rack follower 90 includes a piston surface 104 having a central recess 106. A spring 108 is arranged in central recess 106. A hydraulic plunger 110 is arranged in pressure chamber 86 in operative engagement with spring 108. With this arrangement, spring 108 accommodates some movement of rack follower 90 when compensating pressure is applied to hydraulic plunger 110. Hydraulic plunger 110 includes an outer surface 112 supporting a first seal 114 and a second seal 116. First seal 114 and second seal 116 prevent hydraulic fluid from passing to rack follower 90. With this arrangement, spring 108 remains dry, e.g., not exposed to hydraulic fluid. Housing 82 includes a plug 119 supporting a hydraulic fluid inlet 121 and a hydraulic connector 124. As will be detailed herein, hydraulic fluid enters housing 82 through hydraulic fluid inlet 121 acting on hydraulic plunger 110 which, in turn, acts on rack follower 90 to provide a wear compensating force to rack 62.

Hydraulic fluid inlet 121 is connected to a source of hydraulic pressure 126 as shown in FIG. 2. In accordance with one aspect of the present disclosure, source of hydraulic pressure 126 takes the form of an electronic brake control module (EBCM) 128 including a motor 130 that is selectively activated to generate hydraulic pressure. EBCM 128 includes a pressure sensor 132 that under normal operating conditions detects hydraulic pressure supplied to a brake assembly 134 and under select operating conditions, detects hydraulic pressure supplied to wear compensation system 80. That is, under normal driving conditions, EBCM provides hydraulic pressure to brake assembly 134 to assist braking forces that may be initiated by a driver.

EBCM 128 is fluidically connected to brake assembly 134 through a first conduit 135 including a first valve 136 and to wear compensation system 80 through a second conduit 137 including a second valve 138. First valve 136 and second valve 138 may be solenoid valves that change position, e.g., open/close in response to receiving an electric signal. First valve 136 is a normally open (NO) valve and second valve 138 is a normally closed (NC) valve.

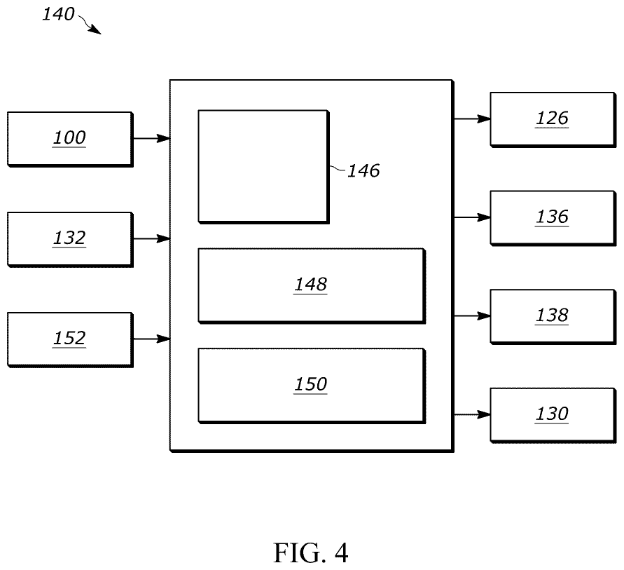

Under normal driving conditions, that is, when vehicle 10 is activated, ECBM 128 supplies hydraulic pressure to brake assembly 134 through first valve 136. Under select operating conditions, for example, when vehicle is turned off, pressure may be applied to wear compensation system 80. In accordance with the present disclosure, vehicle 10 includes a wear compensation controller 140 that activates ECBM 128 to selectively supply hydraulic pressure to wear compensation system 80. Referring to FIG. 4, wear compensation controller 140 includes a central processing unit (CPU) 146, a non-volatile memory 148, and a wear compensation module 150. In addition to storing instructions for wear compensation module 150, non-volatile memory 148 stores a look-up table including torsional force values that may be perceived by steering column 72 due to wear on rack 62 and corresponding wear compensation pressure values that are applied to hydraulic plunger 110. The wear compensation pressure values are targeted at alleviating forces on rack 62 that may be perceived through steering column 72 due to wear.

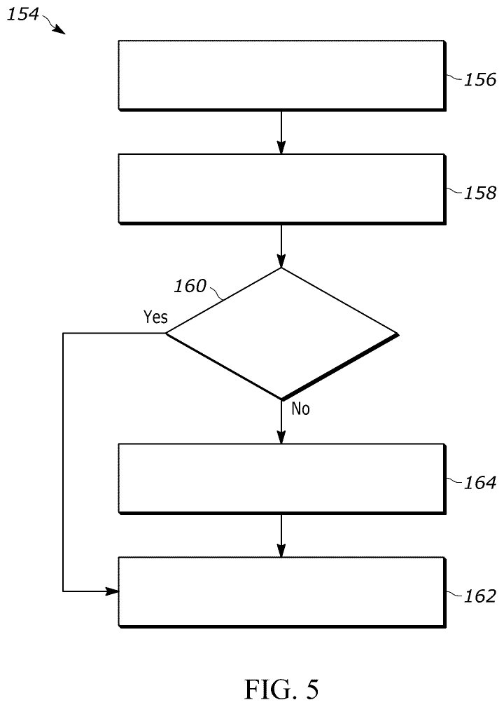

Reference will now follow to FIG. 5 in describing a method 154 of alleviating pressure on rack 62, in accordance with an aspect of the present disclosure. In block 156, upon receiving a signal from vehicle state sensor 152 indicating that vehicle ignition is turned off, wear compensation controller 140 signals first valve 136 to close thereby isolating brake assembly 134 from hydraulic pressure. At the same time, wear compensation controller 140 signals second valve 138 to open thereby fluidically connecting wear compensation system 80 to EBCM 128 and a supply of hydraulic pressure. In block 158 ECBM 128 reads pressure in housing 82.

In block 160, wear compensation module 150 determines if pressure sensed within housing 82 is within selected pressure parameters. The selected pressure parameters balances forces on hydraulic plunger 110 in order to compensate for wear on rack 62. If the pressure is within the selected pressure parameters, second valve 138 is closed and first valve 136 is opened to fluidically reconnect EBCM with brake assembly 134 in block 162.

In this configuration, ECBM 128 is returned to normal operating conditions, e.g., providing pressure to brake assembly 134. If the pressure in housing 82 is not within selected pressure parameters, ECBM 128 is activated to adjust pressure up or down in housing 82 as needed to achieve a selected wear compensation pressure in block 164. Once pressure in housing 82 is within the selected parameters, second valve 138 is closed and first valve 136 is opened to fluidically reconnect EBCM with brake assembly 134 in block 162.

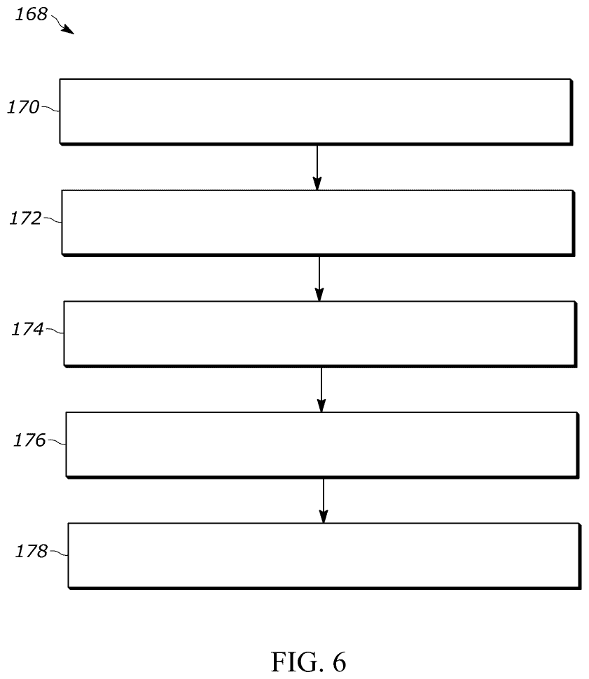

Referring now to FIG. 6, a method 168 for establishing the selected pressure parameters for wear compensation system 80. During vehicle operation, wear compensation controller 140 receives signals from rack sensor 100 in block 170. Wear compensation controller 140 measures pressure changes across rack 62 as perceived through rack sensor 100 in block 172. At this point, a wear profile based on the pressure signals from rack sensor 100 is generated in block 174. The wear profile correlates to pressure differences perceived across rack 62 based on steering inputs through steering column 72. The wear profile is compared with wear compensation pressure values stored in non-volatile memory 148.

In block 178, wear compensation controller 140 opens second valve 138 so that ECBM 128 can provides the wear compensation pressure to wear compensation system 80. The wear compensation pressure applies a force to hydraulic plunger 110 that is transferred to rack 62 through rack follower 90. The wear compensation pressure applies pressure through rack follower 90 and straightens rack 62 so as to alleviate imperfections that may lead to increased steering input forces and undesirable noise caused by wear in steering housing 54. After delivering the wear compensation pressure, wear compensation controller 140 closes second valve 138 and opens first valve 136 to fluidically isolate wear compensation system 80 and fluidically reconnect ECBM 128 with brake assembly 134.

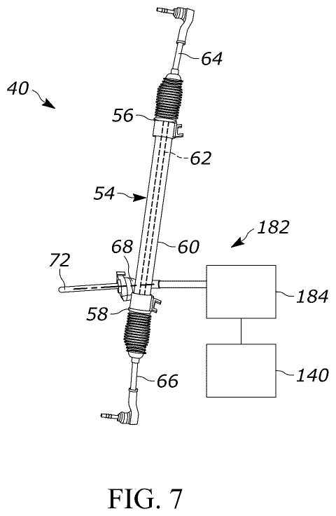

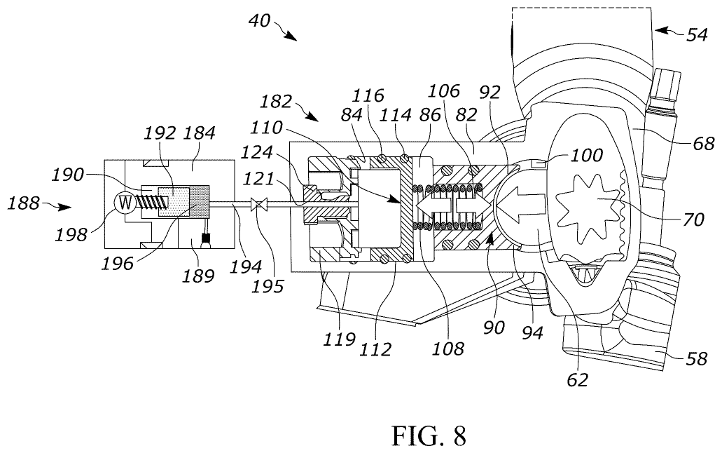

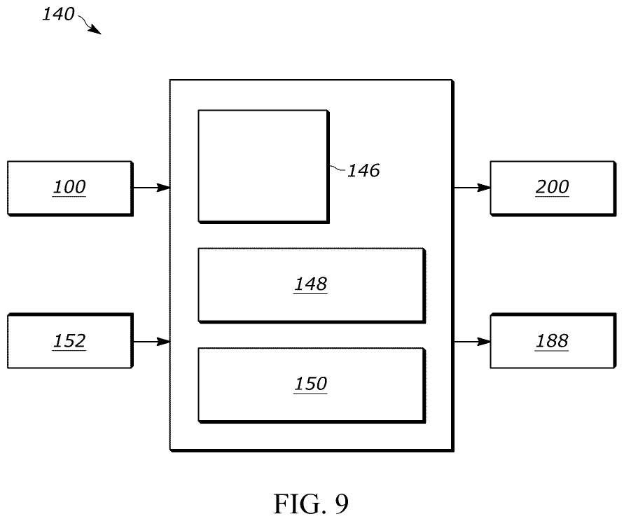

Referring now to FIGS. 7, 8, and 9, a wear compensation system 182 includes a source of hydraulic pressure 184 such as a dedicated steering wear compensation pump 188. Steering wear compensation pump 188 includes a housing 189 having a chamber 190 within which is arranged a piston 192. Chamber 190 includes an outlet 194 controlled by a valve 195. Valve 195 may be a solenoid valve controlled by wear compensation controller 140 that change position, e.g., opens/closes in response to receiving an electric signal. Outlet 194 is directly fluidically connected to hydraulic fluid inlet 121 of housing 82. A hydraulic fluid reservoir 196 is disposed between piston 192 and outlet 194.

Piston 192 is operatively connected to a motor 198 in steering wear compensation pump 188. Motor 198 is activated by wear compensation controller 140 to selectively shift piston 192 in chamber 190 to create hydraulic pressure that acts upon hydraulic plunger 110 in a manner similar to that discussed herein. Steering wear compensation pump 188 includes a pressure sensor 200 that monitors hydraulic pressure derived by piston 192 passing to hydraulic plunger 110 in steering wear compensation system 182.

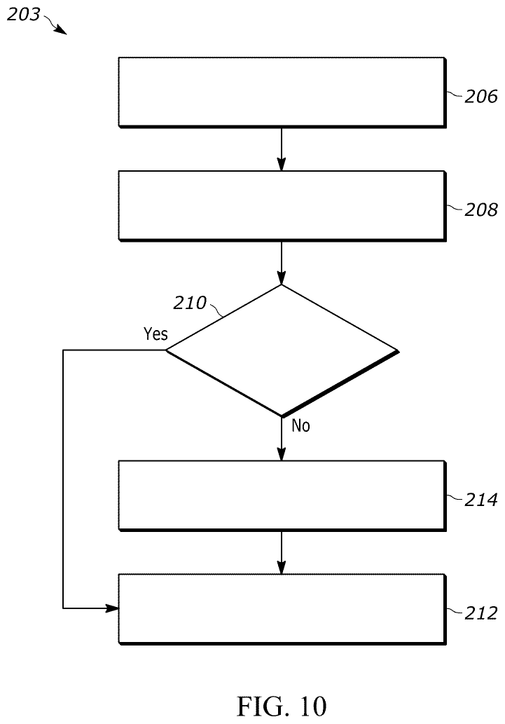

Referring now to FIG. 10, a method 203 of alleviating pressure on rack 62 is shown. In block 206, upon receiving a signal from vehicle state sensor 152 that vehicle ignition is turned off, wear compensation controller 140 signals valve 195 to open exposing wear compensation system 182 to a supply of hydraulic pressure. By providing a dedicated wear compensation pump in wear compensation system 182, the need to open and close valves to isolate the brake assembly is removed. In this manner, wear compensation may be addressed when vehicle is being actively used. In block 208 wear compensation module 150 reads pressure in chamber 190 through pressure sensor 200.

Wear compensation module 150 determines, in block 210, if sensed pressure is within selected wear compensation pressure parameters. The wear compensation pressure parameters are selected to balance forces on hydraulic plunger 110 in order to compensate for wear on rack 62. If the pressure is within the selected wear compensation pressure parameters, valve 195 is closed in block 212. If the pressure in housing 82 is not within selected pressure parameters, motor 198 is activated to adjust wear compensation pressure up or down as needed in block 214. Once the wear compensation pressure in housing 82 is withing the selected parameters, valve 195 is closed in block 212.

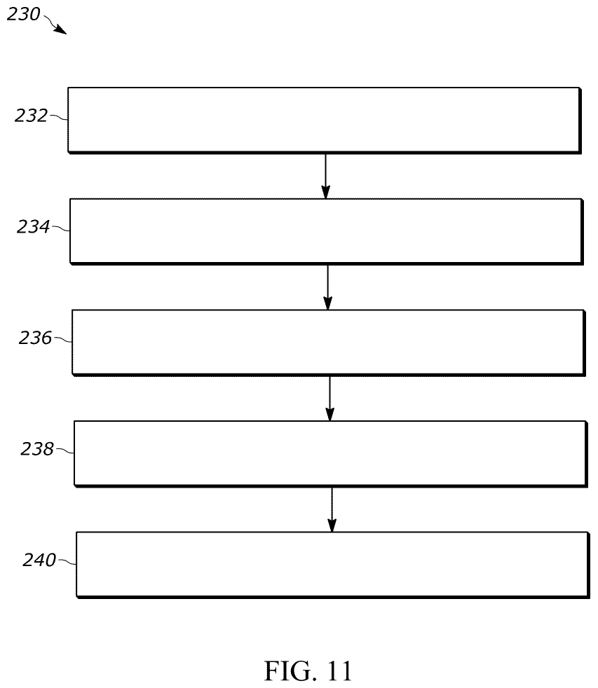

Referring now to FIG. 11, a method 230 for establishing the selected pressure parameters for wear compensation system 182 is shown. During vehicle operations, wear compensation module 150 receives signals from rack sensor 100 in block 232. Wear compensation module 150 measures pressure changes across rack 62 as perceived through rack sensor 100 in block 234. At this point, a wear profile based on the pressure signals from rack sensor 100 in block 236. The wear profile correlates to pressure differences perceived across rack 62 based on steering inputs through steering column 72. The wear profile is compared with wear compensation pressure values stored in non-volatile memory 148 to develop the selected wear compensation pressure parameters for wear compensation system 182 in block 238.

In block 240, steering wear compensation pump 188 provides the wear compensation pressure to wear compensation system 80 in block 240. The wear compensation pressure applies a force to hydraulic plunger 110 that is transferred to rack 62 through rack follower 90. The pressure straightens rack 62 to alleviate imperfections caused by wear that may lead to increased steering input forces and undesirable noise in steering housing 54.

The wear compensation system, in accordance with the present disclosure, includes an active pressure control system that provides pressure to compensate for wear on steering assembly components, such as a steering rack. The compensating pressure is delivered through a hydraulic pump that may be part of another vehicle system, such as the brake assembly, or a dedicated pump with the sole purpose of supplying hydraulic pressure to the wear compensation system. Further, by using and adapting hydraulic pressure to meet steering compensation requirements, the system described in the present disclosure avoids the limitations of mechanical system which have a very narrowly defined range of pressure compensation.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is

1. A wear compensator for a rack and pinion steering assembly having a rack in engagement with a pinion shaft gear in a steering housing, the wear compensator comprising:
a rack follower configured to slidably engage the rack;
a hydraulic plunger configured to selectively apply pressure to the rack follower;
a source of hydraulic pressure operatively connected to the hydraulic plunger;
a rack profile sensor configured to detect forces on the rack resulting from engagement with the pinion shaft gear; and
a wear compensator controller operatively connected to the rack profile sensor and the source of hydraulic pressure, the wear compensator controller being configured to adjust hydraulic pressure on the hydraulic plunger to selectively force the rack follower against the rack based on signals from the rack profile sensor.

2. The wear compensator according to claim 1, wherein the source of hydraulic pressure defines an electronic brake control module (EBCM).

3. The wear compensator according to claim 2, further comprising: a normally closed valve fluidically connected between the hydraulic plunger and the EBCM.

4. The wear compensator according to claim 1, wherein the rack follower includes a central recess exposed to the hydraulic plunger.

5. The wear compensator according to claim 4, further comprising: a spring arranged in the central recess, the spring being operatively connected between the hydraulic plunger and the rack follower.

6. The wear compensator according to claim 1, wherein the source of hydraulic pressure is a steering wear compensation pump directly connected to the hydraulic plunger.

7. A wear compensator for a rack and pinion steering assembly having a rack in engagement with a pinion shaft gear in a steering housing, the wear compensator comprising:
a rack follower configured to slidably engage the rack;
a hydraulic plunger configured to selectively apply pressure to the rack follower;
a source of hydraulic pressure operatively connected to the hydraulic plunger;
a rack profile sensor configured to detect forces on the rack; and
an active pressure controller operatively connected to the rack profile sensor and the source of hydraulic pressure, the active pressure controller activating the source of hydraulic pressure to actively apply hydraulic pressure on the hydraulic plunger selectively forcing the rack follower against the rack based on signals from the rack profile sensor.

8. The wear compensator according to claim 7, wherein the source of hydraulic pressure defines an electronic brake control module (EBCM).

9. The wear compensator according to claim 8, further comprising: a normally closed valve fluidically connected between the hydraulic plunger and the EBCM.

10. The wear compensator according to claim 7, wherein the rack follower includes a central recess exposed to the hydraulic plunger.

11. The wear compensator according to claim 10, further comprising: a spring arranged in the central recess, the spring being operatively connected between the hydraulic plunger and the rack follower.

12. The wear compensator according to claim 7, wherein the source of hydraulic pressure is a steering compensator pump directly connected to the hydraulic plunger.

13. A method of biasing a rack against a pinion to compensate for wear in a steering assembly, the method comprising:
monitoring hydraulic pressure on a hydraulic plunger;
determining whether the hydraulic pressure is within a selected pressure range;
adjusting pressure on the hydraulic plunger if the hydraulic pressure is not within the selected pressure range; and
adjusting pressure on a rack follower of the steering assembly with the hydraulic plunger.

14. The method of claim 13, wherein monitoring hydraulic pressure on the hydraulic plunger includes opening a normally closed valve to fluidically connect the steering assembly with an electronic brake control module (EBCM).

15. The method of claim 13, further comprising: monitoring pressure on the rack of the steering assembly across a rack travel path.

16. The method of claim 15, further comprising: developing a rack wear profile of the rack across the rack travel path.

17. The method of claim 16, wherein developing the rack wear profile includes identifying pressure changes on the rack across the rack travel path.

18. The method of claim 17, further comprising: determining a compensating pressure to balance pressure on the rack based on the rack wear profile.

19. The method of claim 18, wherein adjusting the pressure on the hydraulic plunger includes applying the compensating pressure to the hydraulic plunger.

20. The method of claim 19, wherein applying the compensating pressure includes activating a steering wear compensation pump directly connected to the hydraulic plunger.
